(19) United States
(12) Patent Application Publication
(10) Pub. No.: US 2022/0212441 A1
(43) Pub. Date: Jul. 7, 2022

(54) SUEDE-LIKE SURFACE MATERIALS FOR VEHICLE INTERIORS

(71) Applicants: HAYASHI TELEMPU CORPORATION, Nagoya-shi (JP); HONDA MOTOR CO., LTD., Tokyo (JP)

(72) Inventors: Tetsuya Ogawa, Nagoya-shi (JP); Masaomi Takai, Nagoya-shi (JP); Tomoyuki Uemura, Tokyo (JP)

(21) Appl. No.: 17/454,588

(22) Filed: Nov. 11, 2021

(30) Foreign Application Priority Data
Nov. 13, 2020 (JP) 2020-189776

(51) Int. Cl. B32B 5/26; B32B 7/12

(52) U.S. Cl. CPC B32B 5/2795; B32B 7/12; B32B 2255/26; B32B 2605/003; B32B 2262/16; B32B 2262/0276; B32B 2255/02

(57) ABSTRACT

The present invention provides a suede-like surface material, which is more elongated, more friction-robust than conventional products, and is relatively inexpensive in terms of price, and especially suitable for vehicle interior.

The suede-like surface material for vehicle interior having at least a surface layer, an adhesive layer and a rear surface layer.

The surface layer comprises a textile containing a split yarn, the textile preferably includes a warp yarn comprising a combined twisted yarn containing a split yarn and a high stretching yarn or a high shrinkage yarn, and a weft yarn comprising a polyester crimped yarn.

The adhesive layer comprises polyester-based adhesive, preferably a solvent-free polyester-based polyurethane adhesive.

Depending on the application, the rear surface layer is a knitted material whose knitted tissue is a tricot or a jersey.

### TECHNICAL FIELD

The present invention relates to suede-like surface materials for vehicle interion, and more particularly, to suede-like surface materials for vehicle interior which have high elongation performance, are excellent in friction durability, and are excellent in cost performance.

### BACKGROUND ART

In the past, suede-like surface materials have been used in various fields because of their flexible texture and luxurious feel.

For example, Patent Document 1 discloses a bulky brushed non-woven fabric for automotive interiors a nonwoven fabric design layer forming a pile in which a part of a constituent fiber protrudes, and a non-woven fabric base layer integrally laminated with the design layer and having a shape retention enhancing function and a buffer function, and comprising a short fiber of a thermoplastic synthetic fiber as a whole.

Conventional suede surface skin is generally impregnated with a polyurethane resin composition into a dough to give a feeling of wetting in texture. For example, Patent Document 2 discloses a polyurethane resin composition obtained using a polytetrarnethylene carbonate diol, and this polyurethane resin composition is used by applying directly to a base material or applying it via an intermediate layer or an adhesive layer.

On the other hand, split yarns (ultrafine fibers) are known as fibers with excellent wiping performance such as oil content and fingerprints.

For example, as an example of use of split yarns (ultrafine fibers), Patent Document 3 discloses a portable terminal storage bag comprising a brushed surface in which at least a surface of a dough in contact with a portable terminal forms a split yarn in a brushed shape.

This split yarns (ultrafine fibers) is also used in suede-like surface materials to obtain the soft texture and feel of suede.

### PRIOR ART LITERATURE

### Patent Documents

Patent Document 1: JP3715731
Patent Document 2: JP3281126
Patent Document 3: JP2012-243078

### SUMMARY OF INVENTION

### Problems to be Solved by Invention

A polyurethane resin composition used in a suede-like surface skin can give texture of a dough a feeling of wetting.

However, as a contrary, there is a problem of deterioration of the coloring performance, which is typified by the friction robustness.

This is derived from the transfer of dye to the polyurethane resin and the color contaminated polyurethane resin peels off.

In addition to the fact that suede-like surface skin has low elongation and therefore limited applications, suede-like surface materials using split yarns tend to have high manufacturing costs.

Therefore, the purpose of this invention is to provide a suede-like surface material, especially suitable for vehicle interior materials, which is more elongated, more friction-robust than conventional products, and is relatively inexpensive in terms of price.

### Solution to Problem

The present invention has been made in order to achieve the above problem, and has the following configuration.

<1> A suede-like surface material for vehicle interior having at least a surface layer, an adhesive layer and a rear surface layer, wherein the surface layer comprises a textile containing a split yarn.

<2> The suede-like surface material according to <1>, wherein the textile includes a warp yarn comprising a combined twisted yarn containing a split yarn and a high stretching yarn or a high shrinkage yarn, and a weft yarn comprising a polyester crimped yarn.

<3> The suede-like surface material according to <1> or <2>, wherein the adhesive layer comprises a solvent-free polyester-based polyurethane adhesive.

<4> The suede-like surface material according to any one of <1> to <3>, wherein the rear surface layer comprises a knitted material and a tissue of the knitted material is a tricot or a jersey.

### Advantageous Effects of Invention

According to the present invention, it is possible to provide a suede-like surface material, which is more elongated, more friction-robust than conventional products, and is relatively inexpensive in terms of price, and especially suitable for vehicle interior materials.

### BRIEF DESCRIPTION OF DRAWINGS

FIG. 1 shows a schematic cross-sectional view of the Example product (A) of Example 1.

FIG. 2 shows a schematic cross-sectional view of Comparative products (A) and (B) of Comparative Examples 1 and 2.

FIG. 3A shows graphs of the elongation by specific loads (short booklet) in the longitudinal direction of the Example product (A), the Comparative products (B) and (C).

FIG. 3B shows graphs of the elongation by specific loads (short booklet) in the lateral direction of the Example product (A), the Comparative products (B) and (C).

FIG. 3C shows graphs of the elongation by specific loads (short booklet) in the bias R direction of the Example product (A), the Comparative products (B) and (C).

FIG. 3D shows graphs of the elongation by specific loads (short booklet) in the bias L direction of the Example product (A), the Comparative products (B) and (C).

FIG. 4A shows graphs of the required load by specific elongation (circular) in the longitudinal direction of the Example product (A), the Comparative products (B) and (C).

FIG. 4B shows graphs of the required load by specific elongation (circular) in the lateral direction of the Example product (A), the Comparative products (B) and (C).

FIG. 4C shows graphs of the required load by specific elongation (circular) in the bias R direction of the Example product (A), the Comparative products (B) and (C).

FIG. 4D shows graphs of the required load by specific elongation (circular) in the bias L direction of the Example product (A), the Comparative products (B) and (C).

FIG. 5A shows graphs of the surface friction properties (smoothness) (1) in the longitudinal direction of the Example product (A), the Comparative products (B) and (C).

FIG. 5B shows graphs of the surface friction properties (smoothness) (1) in the lateral direction of the Example product (A), the Comparative products (B) and (C).

FIG. 6A shows graphs of the surface friction properties (smoothness) (2) in the longitudinal direction, etc. of the Example product (A), the Comparative products (B) and (C).

FIG. 6B shows graphs of the surface friction properties (smoothness) (2) in the lateral direction, etc. of the Example product (A), the Comparative products (B) and (C).

FIG. 7A shows graphs of the changes in intensity physical properties in the presence and absence of rear base fabric in the longitudinal direction of the Example product (A), the Comparative products (B) and (C).

FIG. 7B shows graphs of the changes in intensity physical properties in the presence and absence of rear base fabric in the lateral direction of the Example product (A), the Comparative products (B) and (C).

FIG. 8 show a graph of the air permeability of the Example product (A), the Comparative products (B) and (C).

### Air Permeability

### DESCRIPTION OF EMBODIMENTS

In order to solve the problem of the conventional suede-like surface material, which has a low elongation performance, poor friction robustness, and tended to cost high production costs, the present inventors conducted a further study and found that the above problems could be solved by adopting three layers of suede-like surface material: a surface layer, an adhesive layer, and a rear surface layer, and by confining the use of split yarns to a portion of the surface layer.

The configuration of the present invention is described in the following order.

The suede-like surface material of the present invention comprises a surface layer, a rear surface layer, and an adhesive layer interposed between the surface layer and the rear surface layer, wherein the surface layer comprises a textile containing a split yarn, and the adhesive layer contains a polyester-based adhesive.

### (Surface Layer)

The surface layer comprises a textile containing a split yarn, preferably a high-density textile, which serves to express a texture as suede-like feeling of wetting.

In a conventional suede-like surface material, a polyurethane resin composition is impregnated into a dough to give texture a feeling of wetting in order to exhibit texture like as a suede-like feeling of wetting.

However, this polyurethane resin composition causes a decrease in friction fastness and an increase in cost, as described above.

On the other hand, in the present invention, since the polyurethane resin composition is not used in the surface layer and the split yarn expresses texture having a unique feeling of wetting, a decrease in friction fastness is suppressed.

In the textile, a split yarn is used for a warp yarn.

The use of the split yarn as part of the textile can reduce the amount used of the split yarn, which is a factor in the cost increase.

And, since it is not a weft yarn but a warp yarn that affects the texture of the suede-like surface material, the texture of the suede-like surface material can be expressed sufficiently by using the split yarn for the warp yarn.

The form (structure) of the textile is not particularly limited, and any of plain weave, twill weave, and satin weave may be used, but satin weave is desirable when a dense surface texture is required.

The split yarn used in the textile is a yarn obtained by discharging a synthetic resin which is not dissolved in a specific solvent and a synthetic resin which is dissolved in a specific solvent from a plurality of nozzles in a molten state, performing mixing and spinning while being combined, and then dissolving and removing a constituent resin which is dissolved in the specific solvent.

Examples of the combination of the synthetic resin which does not dissolve in the specific solvent and the synthetic resin which dissolves in the specific solvent include the combination of nylon (registered trademark) and an alkaline easily soluble polyester, but the present invention is not limited thereto, and any known synthetic resin may be used in combination as long as the same effect can be obtained.

The split yarn preferably has a single-filament fineness of 0.07 dtex or more and 0.44 dtex or less, more preferably 0.10 dtex or more and 0.22 dtex or less, and preferably has a total fineness of 84 dtex or more and 330 dtex or less, and more preferably 84 dtex or more and 167 dtex or less.

The single-filament fineness in the above range provides a smooth surface feel and dense surface texture.

And, the total fineness in the above range provides volume sensation and strength performance necessary for vehicle interior material as a suede dough

There are two major types of the split yarn: a raw yarn (citrus type), which is subdivided by physical division, and a raw yarn (sea-island type), which is subdivided by drug division which uses alkaline treatment.

The use of the latter split yarn is preferred to reproduce high-grade texture and touching.

It is more preferable to use a split yarn, which is a sea-island type of 84T/24F and has 16 divisions in terms of good texture as a suede and maintaining the physical properties required when used on the vehicle.

These split yarns include commercial products such as clothing, shoes, and miscellaneous items.

The warp yarn preferably comprises a combined twisted yarn containing a split yarn and a high stretching yarn (a yarn with excellent elasticity) or a high shrinkage yarn (a yarn with excellent shrinkage).

The use of the high stretching yarn or the high shrinkage yarn as a raw yarn can compensate for the low elasticity of the split yarn.

A high stretching polyester yarn and a high crimp polyester yarn can be used as such the high stretching yarn, but if higher elongation performance is required in terms of the elasticity of the finished product after dyeing and finishing, the high stretching yarn such as polytrimethylene terephthalate (PTT) or polybutylene terephthalate (PBT), which have excellent elasticity, may be used.

The high stretching yarn or the high shrinkage yarn preferably has a single-filament fineness of 2.5 dtex or more and 4.0 dtex or less, and preferably has a total fineness of 33 dtex or more and 84 dtex or less, and more preferably 33 dtex or more and 55 dtex or less.

When the single-filament fineness and the total fineness fall within the above range, good hair-raising property can be secured, and a high elongation can be given as a raw combined twisted yarn without impairing the surface feel and the texture of the split yarn.

For the combined twisted yarn of the split yarn and the high stretching yarn or the high shrinkage yarn, the number of twists preferably is 50 times/m or more and 300 times/m or less, and particularly preferably 100 times/m or more and 200 times/m or less, but from the point of view of design, texture, performance and price, the combination by interlacing is relatively preferable.

When the number of twists falls within the above range, it is possible to produce a harmonious product without impairing either design, texture or performance.

The density of the warp yarn constituting the textile is preferably 200 lines/inch or more and 300 lines/inch or less, and particularly preferably 220 lines/inch or more and 270 lines/inch or less, at the time of finishing.

When the density of the warp yarn falls with the above range, a dense surface texture can be given at finishing as the suede textile.

It is preferable that the weft yarn includes a crimped yarn.

The crimped yarn preferably has a single-filament fineness of 1.2 dtex or more and 3.5 dtex or less, more preferably 2.0 dtex or more and 3.5 dtex or less, and preferably has a total fineness of 55 dtex or more and 330 dtex or less, and more preferably 84 dtex or more and 167 dtex or less.

When the single-filament fineness falls within the above range, the textile has high elongation performance in the lateral direction as well as in the longitudinal direction, and it is possible to secure the high-density quality with good elongation balance of longitudinal direction/lateral direction.

The crimped yarn preferably has a crimp ratio of 20% or more and 60% or less, and more preferably 30% or more and 50% or less.

When the crimp ratio falls within the above range, it is possible to achieve the high density of the textile and a good elongation balance of longitudinal direction/lateral direction.

Further, in the textile, a density of the weft yarn is preferably 80 lines/inch or more and 150 lines/inch or less and more preferably 100 lines/inch or more and 130 lines/inch or less at the time of finishing.

When the density of the weft yarn falls within the above range, it is possible to ensure a dense appearance texture, a smooth feel, and a good elongation balance of longitudinal direction/lateral direction.

As described above, it is preferable that the surface layer comprises the combined twisted yarn includes the split yarn and the polytrimethylene terephthalate (PTT) yarn, and the weft yarn includes the crimped yarn.

Conventional suede-like surface materials have low elongation and are unsuitable for sheet tailoring and sticking to trim parts such as doors, and their applications have been limited, such as vehicle seats, where high elongation is not required.

In contrast, in the present invention, the PTT yarn and the crimped yarn having high stretchability are used as raw yarns

Therefore, as a final product, elongation (constant load elongation) of 10% or more at 10 kg load in longitudinal direction/lateral direction can be ensured.

Further, it is suitable for adhesion to the trim parts such as sheet tailoring and doors, good bonding and tailoring can be expected even in molded parts such as doors and instrument panels.

In this invention, constant load elongation means a value measured by the method described in the evaluation method described in Examples.

The surface layer preferably has a basis weight of 150 g/m² or more and 300 g/m² or less, and particularly preferably 170 g/m² or more and 230 g/m² or less.

The above range of weights ensures merchantability while keeping production costs low.

The surface layer preferably has the thickness of 0.3 mm or more and 0.8 mm or less, and more preferably 0.4 mm or more and 0.6 mm or less.

When the thickness is in the above range, the amount of split filament used, which is a factor of the cost increase, can be appropriately adjusted.

On the other hand, the reduction in physical properties such as thickness (volume) and strength can be supplemented by the installation of the rear surface layer as described below.

The method of producing the surface layer is not particularly limited and can be produced by a known method, but can be produced, for example, by passing through a step of a raw machine, a relaxing process, a weight reduction process, a dehydration, a dyeing, a dehydration, a hair-raising agent imparting, a hair raising, and a final set.

The surface layer may be further processed on its surface depending on the application, and for example, a buffing (emery) process may be performed on the surface of the textile in order to realize a good raised texture.

### (Rear Surface Layer)

The rear surface layer plays a complementary role by forming a complex with the surface layer for the textile thickness (volume) and performance of the surface layer.

The rear surface layer can also confer various functionalities by changing the surface skin to be applied depending on the characteristics required for the finished body, such as strength, elongation, thickness, and burning properties.

### (Jersey)

For example, when there is a requirement for high elongation as a finished body, it is preferable to use a knitted material (jersey) in which a tissue of the knitted material is round knitted, which is superior in elongation characteristics to a suede textile of the surface layer.

In this case, as the raw yarn configuration, it is preferable to use a PET yarn having a thickness of 55 dtex or more and 450 dtex or less.

The basis weight of the rear surface layer in the case of jersey is preferably 200 g/m² or more and 500 g/m² or less, and particularly preferably 250 g/m² or more and 350 g/m² or less, but there is no problem in selecting an appropriate weight according to the requirement performance.

The density of the rear surface layer in the case of jersey is preferably 35 lines/inch or more and 40 lines/inch or less in the well direction and 35 lines/inch or more and 45 lines/inch or less in the course direction, and the thickness is preferably 0.5 mm or more and 1.5 mm or less, but there is no problem in selecting a thickness and weight suitable for the requirements in accordance with the required performance.

### (Tricot)

When elongation characteristics are not required as a finished body or when a hole drilling by perforation process are required for post-processing, it is preferable to use a knitted material having a low elongation, hardly unraveling, a high density, and a knitted tissue of a tricot.

In this case, as the raw yarn configuration, it is preferable to use a PET yarn having a thickness of 84 dtex or more and 3300 dtex or less.

The basis weight of the rear surface layer in the case of the tricot is preferably 200 g/m² or more and 500 g/m² or less, and particularly preferably 250 g/m² or more and 450 g/m² or less, but there is no problem in selecting an appropriate weight according to the demand performance.

In the case of the tricot, the density of the rear surface layer is preferably 30 lines/inch or more and 45 lines/inch or less in the well direction and 50 lines/inch or more and 65 lines/inch or less in the course direction, and the thickness is preferably 0.5 mm or more and 1.5 mm or less, but there is no problem in selecting a weight suitable for the requirements in accordance with the required performance.

Although the thickness of the rear surface layer is modified as appropriate from the characteristics required for a finished body and is not particularly limited, it is preferably at least 0.5 mm or more from the need to complement the thickness (volume) and performance of the finished body by forming a complex with the surface layer, and it is preferably 1.0 mm or more. However, there is no problem in selecting the appropriate thickness for that requirement according to the performance requirement or cost setting.

In addition, in the rear surface layer, it is desirable that the surface state of the rear surface layer is in a flat surface state without as much as possible concavity in order to prevent concave-convex transcription to the surface of the suede textile of the surface layer.

The rear surface layer can be produced by a known method in both cases of the jersey and the tricot, and there is no limitation on the producing method thereof, but for example, in the case of the jersey, it can be produced by a knitting, a dyeing, a dehydration, a resin processing, and a setting, and in the case of tricot, it can be finished through a similar process.

Further, the rear surface layer can have a feeling of thickness and elasticity more than those of ordinary suede by laminating a fabric having a thickness of 1 mm or more, and can have a feeling of unevenness more effective than that of ordinary textile skin for finishing a design secondary processing accompanied by expressions of unevenness such as embossing or quilting.

With respect to flame retardancy imparting, it is possible to impart an arbitrary ratio to the rear surface layer in a dipping process a specific flame retardant.

And, the degree of freedom is obtained on the flame retardance strength by the requirement performance, because it is a dipping treatment.

### (Adhesive Layer)

The adhesive layer plays a role in bonding (adhesion) the surface layer and the rear surface layers.

As an adhesive for forming this adhesive layer, a known adhesive can be used without limitation as long as it serves to bond (adhere) the surface layer and the rear surface layer.

Such adhesives include polyester-based adhesives such as polyester-based polyurethane adhesives, as well as polyether-based polyurethane adhesives and polycarbonate polyurethane adhesives, any of which may be used.

As the polyester-based polyurethane adhesive, for example, a solvent-based, water-based, or solid hot-melt-based adhesive resin is present, and any of them may be used, but it is preferable to use a solvent-free type without taking into consideration the environmental characteristics of the vehicle SPEC

Further, when the adhesive strength and durability are considered, it is more preferable to use a moisture-curable hot-melt urethane resin which is solvent-free and does not require a drying step as an adhesive.

When considering adverse effects on the performance other than the peel strength, the coating weight of the adhesive layer is preferably 20 g/m² or more and 60 g/m² or less, and more preferably 35 g/m² or more and 50 g/m² or less.

The adhesive layer is formed by applying a coating amount of 20 g/m² or more and 60 g/m² or less using a specific bonding machine.

In addition, when venting is required for the product, it is bonded by point adhesion.

When an elongation is required for a finished product, it is desirable to apply an adhesive to the front side of the rear surface layer, and when an elongation is not required, it is desirable to apply an adhesive to the back side of the surface layer.

For the formation of the adhesive layer, a curing time is required, generally 48 hours or more and 72 hours or less is desirable, and the environmental conditions are 40° C.×55% RH.

The formation of the adhesive layer requires a curing time, and a curing time of about 48 hours or more and 72 hours or less is desirable, and as an environmental condition, an environment at 40° C.×55% RH is desirable.

Since the suede-like surface material of the present invention with the above configurations have approximately 10% extension in the longitudinal/lateral direction at constant load stretching, it can be used in a wider range of applications compared to the conventional suede-like surface material with low elongation and limited application. And, it has the overwhelming price advantage in comparison with the conventional suede-like surface material.

### EXAMPLES

Herein, the present invention is specifically illustrated by Examples and Comparative Examples.

The measurement of each item in the Example was based on the following method.

### <Example 1> the Configuration of the Suede-Like Surface Material of the Present Invention

A PET split filament-containing high-density textile having a basis weight of 180 g/m², as a surface layer, and a knitted material (knit) having a basis weight of 260 g/m², as a rear surface layer, were produced by a known method.

On the front side of the obtained rear surface layer, a bonding machine was used, a solvent-free polycarbonate-based urethane adhesive was applied, and the surface layer and the rear surface layer were bonded by point adhesion.

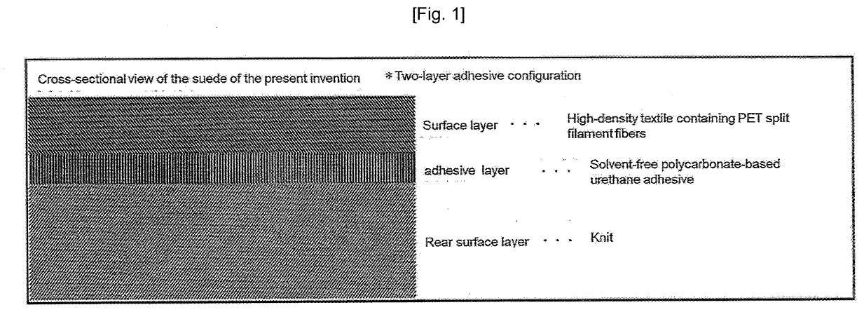

After curing at 40° C.×55% RH for 48 to 72 hours, an adhesive layer with a thickness of 35 g/m² was formed between the surface layer and the rear surface layer to produce an Example product (A), which is a suede-like surface material of the present invention having a cross-sectional configuration shown in FIG. 1 (also referred to simply as “A” in the graphs shown below). The thickness of the Example product (A) was 1.2 mm.

### <Comparative Example 1> the Configuration of the Similar Suede-Like Surface Material for Comparative Evaluation

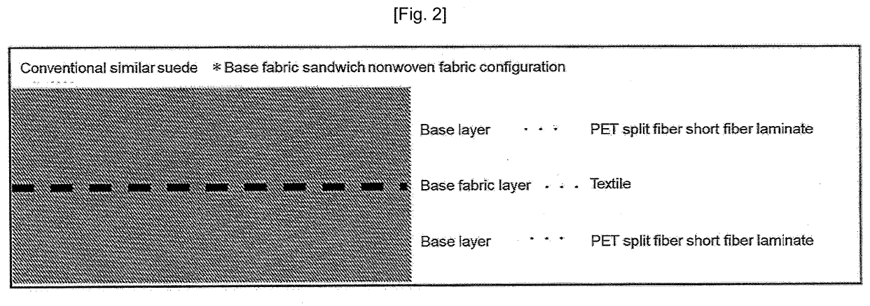

A Comparative product (B) (also referred to simply as “B” in the graphs shown below), which is a similar suede-like surface material for comparative evaluation, was produced (see FIG. 2).

The Comparative product (B) had a structure in which a textile which is a base fabric layer is sandwiched between two base layers of PET split fiber short fiber laminate having a basis weight of 460 g/m², was produced (see FIG. 2).

The thickness of the comparative product (B) was 1.1 mm.

### <Comparative Example 2> the Configuration of the Similar Suede-Like Surface Material for Comparative Evaluation

A Comparative product (C) (also referred to simply as “C” in the graphs shown below), which is a similar suede-like surface material for comparative evaluation, was produced (see FIG. 2).

The Comparative product (C) had the same configuration except that the basis weight of the two base layers of PET split fiber short fiber laminate was changed to 300 g/m² in Comparative Example 1.

The thickness of the comparative product (C) was 1.0 mm.

The obtained Example product (A) and Comparative products (B) and (C) were evaluated by the following methods.

### <Elongation by Specific Loads (Short Booklet)>

The resulting Example product (A) and Comparative products (B) and (C) were processed into a test sample of a specified size, attached to a tensile testing machine of the constant rate elongation type (Type version RTC1310A manufactured by Orientec), at a constant speed (200 mm/min), in each direction (longitudinal direction, lateral direction, bias R direction, bias L direction) pulling against, and constant load elongations at 1 kg, 2.5 kg, 5 kg, 7 kg, 10 kg load respectively, and elongation at break were calculated.

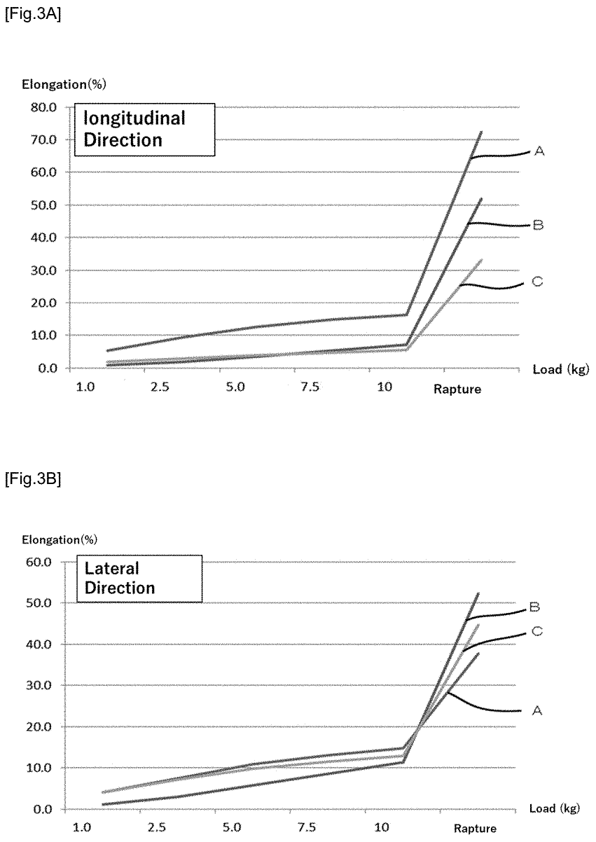

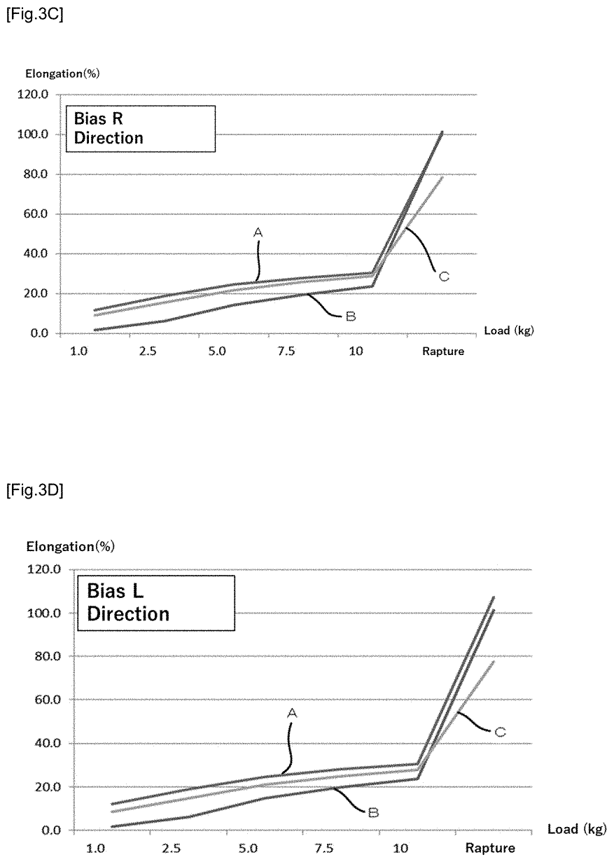

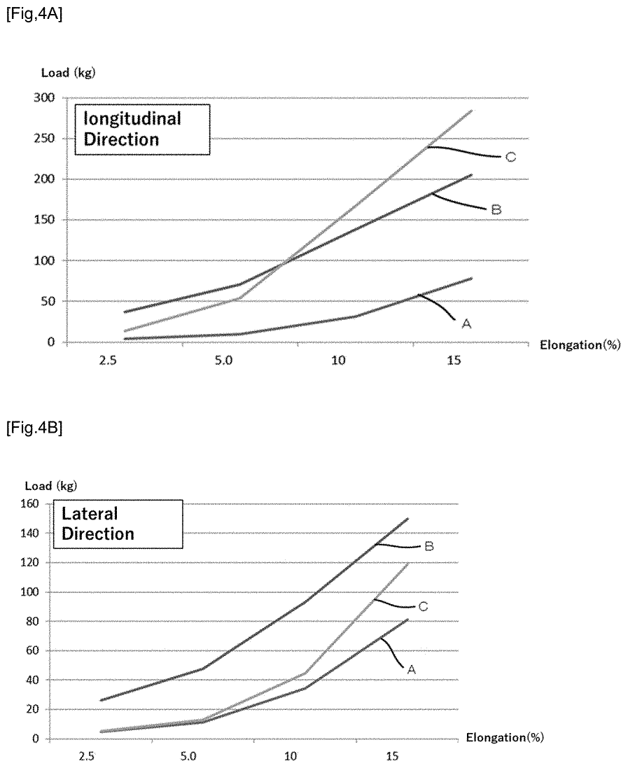

The results are shown in FIGS. 3A to 3D.

FIG. 3A shows that the elongation in the longitudinal direction of the Example product (A) was higher than that of the Comparative products (B) and (C) from 1 kg load to the time of failure.

FIG. 3B shows that the elongation in the lateral direction of the Example product (A) was higher than that of the Comparative products (B) and (C) from 1 kg load to the time of rapture.

FIGS. 3C and 3D show that in both biased directions, the elongation of the Example product (A) was higher than that of the Comparative products (B) and (C) from 1 kg load to the time of rapture.

Overall, it could be confirmed that it was a sued with a higher degree of elongation than a similar product in all directions.

And, the superiority especially in the longitudinal direction could be confirmed.

### <Required Load by Specific Elongation (Circular)>

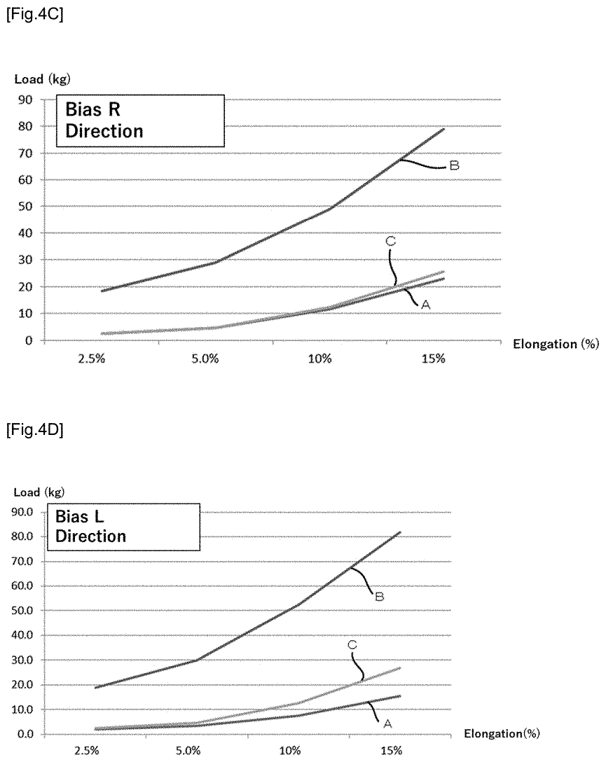

The test samples obtained by cutting the resulting Example product (A) and Comparative products (B) and (C) in a circular shape having a diameter of 300 mm, were pulled at a constant speed (200 mm/min) in each direction (the longitudinal direction, the lateral direction, the bias R direction, and the bias L direction) using an constant rate elongation type Instron type tensile tester (RTG1210 manufactured by Orientec), a load-elongation curve was obtained and the loads at 2.5%, 5.0%, 10% and 15% elongation was read from the load-elongation curve. The results are shown in FIGS. 4A to 4D.

From FIG. 4A, it was confirmed that the load required to obtain 2.5 to 15% elongation in the longitudinal direction was lower in the Example product (A) than in the Comparative products (B) and (C).

From FIG. 4B, it was confirmed that the load required to obtain 2.5 to 15% elongation in the lateral direction was lower in the Example product (A) than in the Comparative products (B) and (C).

From FIGS. 4C and 4D, it was confirmed that the load required to obtain 2.5 to 15% elongation in the both bias direction was lower in the Example Product (A) than in the Comparative products (B) and (C).

Overall, it was confirmed that higher elongation could be obtained with the Example product (A) than with the Comparative products (B) and (C) at lower loads in all directions.

And, the superiority especially in the longitudinal direction could be confirmed.

### <Surface Friction Properties (Smoothness) (1)>

Surface friction properties (smoothness) (1) of the resulting Example product (A) and the Comparative products (B) and (C) were evaluated by the following methods:

Specifically, the Example product (A) and the Comparative products (B) and (C) were cut at 200×200 mm to make the test samples, and KES-FB4 surface testing machine (manufactured by KATO TECH CO., LTD) was used, the silicone was used for (surface) friction as a contactor, and the piano line was used for (surface) roughness, and the resulting test samples were moved at a constant rate (0.1 cm/sec) to measure the frictional properties of the test samples and the concave-convex condition (surface of the test sample).

MIU (average friction coefficient), MMD (variation of the average friction coefficient), and SMD (average deviation of surface roughness) were calculated from the obtained measurements.

MIU (average friction coefficient), MMD (variation of the average friction coefficient), and SMD (average deviation of the surface roughness) were calculated by fitting the measured value to the following formula.

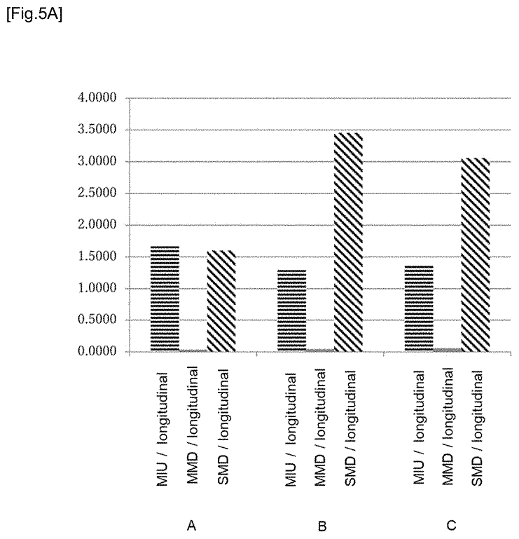

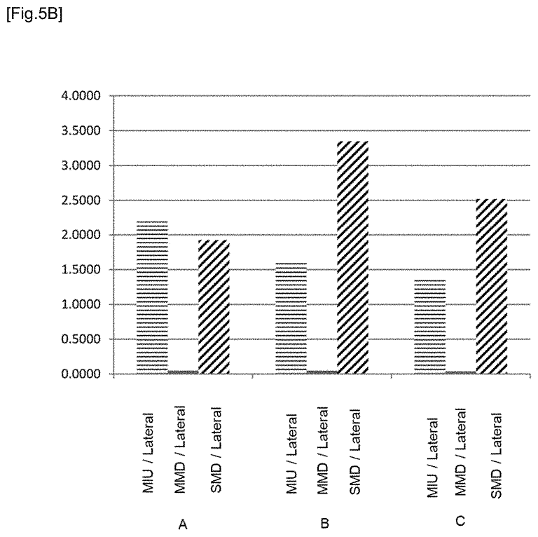

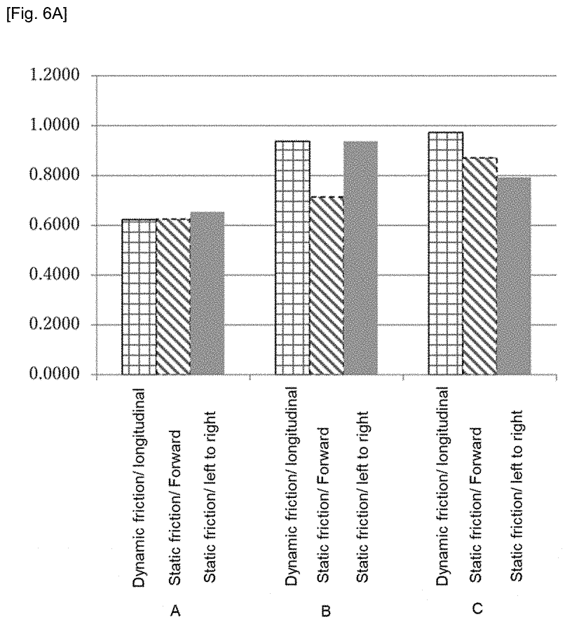

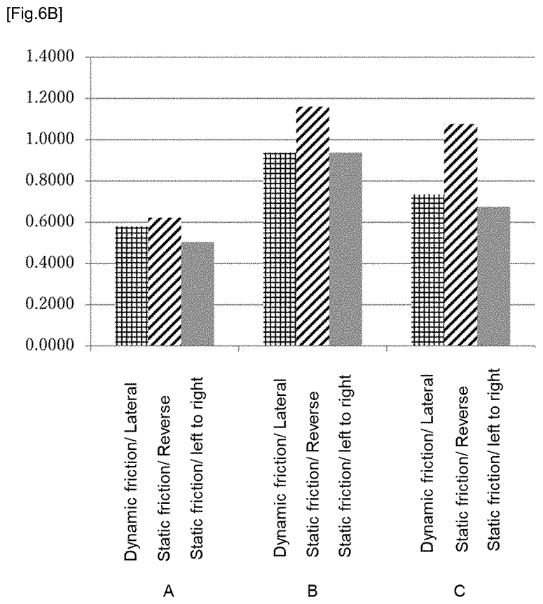

The results are shown in FIGS. 5A and 5B.

$$MIU ( average friction coefficient ) = \frac{1}{x} {\int }_{0}^{x} μ dx ( - ) \qquad [ Formula 1 ]$$

x: Position of contactor on test sample (Moving distance)

$$MMD ( variation of average friction coefficient ) = \frac{1}{x} {\int }_{0}^{x} \vert μ - \overline{μ} \vert dx ( - ) \qquad [ Formula 2 ]$$

x: Position of contactor on test sample (Moving distance)

μ: Friction coefficient (=Friction force F/Static load W)

μ̅: Average friction coefficient

$$SMD ( average deviation of surface roughness ) = \frac{1}{x} {\int }_{0}^{x} \vert T - \overline{T} \vert dx ( μ m ) \qquad [ Formula 3 ]$$

x: Position of contactor on test sample (Moving distance)

T: Thickness at position X on test sample

T̅: Average thickness of test sample

FIG. 5A showed that MIUs (A>B, C) and MMD/SMD (A<B, C). All properties tended to indicate that A was smooth.

FIG. 5B showed that MIU (A>B, C) and MMD/SMD (A<B, C). All properties tended to indicate that A was smooth.

<Surface Friction Properties (Smoothness) (2)>

Surface friction properties (smoothness) (2) of the resulting Example product (A) and the Comparative products (B) and (C) were evaluated by the following methods:

Specifically, the test samples of the Example product (A) and Comparative products (B) and (C) were processed into 500×500 mm square for dynamic friction and 100×150 mm square for static friction.

The friction coefficient was calculated by placing a thread (80 mm in diameter, 705 g in mass) wrapped in a cotton cloth specified in JIS L 0803 above the test sample, pulling it laterally with a push-pull gauge (PS-100N manufactured by IMADA) at a constant velocity (0.1 m/sec.) in the longitudinal and lateral directions, respectively, and calculating the friction coefficient from the values at the time the gauge remained constant.

μ(dynamic friction coefficient)=F(constant value)/A(weight of the sliding piece) [Formula 4]

Measurements were made three times each in the longitudinal direction (forward and reverse) and in the lateral direction (forward and reverse)

The static friction coefficient was determined by the following methods:

The test sample was placed on the inclined plate of the testing machine (SLIP ANGLE TESTER AN manufactured by TOYOSEIKI).

The angle (θ) at which the thread (mass 1500 g, wrapped in white canvas) on top of the test sample starts to slide down the slope with increasing inclination angle was measured and the friction coefficient (tan θ) was calculated from this angle (θ).

The inclination speed was set at 2.7°/s.

The thread was measured for forward direction, reverse direction, right to left direction, left to right direction for the test sample, respectively,

The results are shown in FIGS. 6A and 6B.

From FIG. 6A, it could be confirmed that all directions have low values and smooth surface properties of the Example product (A).

From FIG. 6B, it could be confirmed that all directions have low values and smooth surface properties of the Example product (A).

<Changes in Intensity Physical Properties in the Presence and Absence of Rear Base Fabric>

The following tests were conducted on the surface layer alone (before adhesion of the rear surface layer to the surface layer) (described in the table below as “no rear base fabric” in A) and on the Example product (A) obtained by adhesion of the rear surface layer to the surface layer (described as “with rear base fabric” in the table below).

Tensile Strength

A test samples of the defined size was prepared, this test samples was attached to a tensile tester of the constant rate elongation type, pulled at a constant speed, the maximum load at break (tensile strength) was measured.

Tear Strength

A test sample of defined size was prepared and cut into its central part and pulled similarly to measure load at tear (tear strength).

Two test samples of defined size were stitched under defined conditions and pulled similarly to measure the load (stitch strength) at the time of stitch amputation.

These measurements were performed for each of the longitudinal and lateral directions.

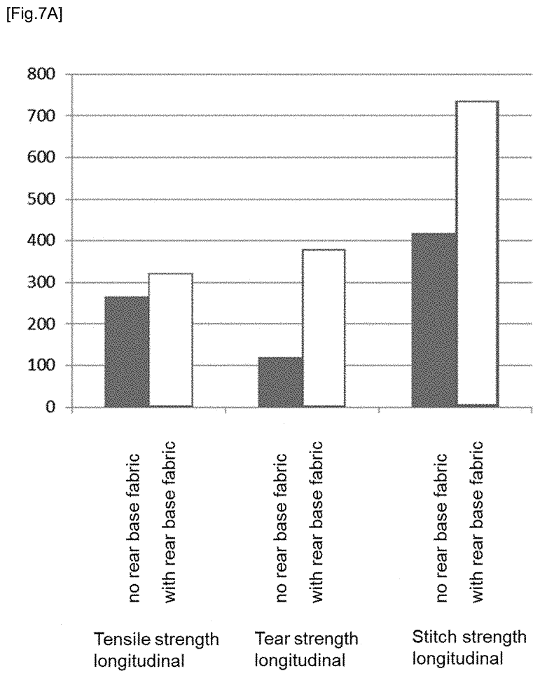

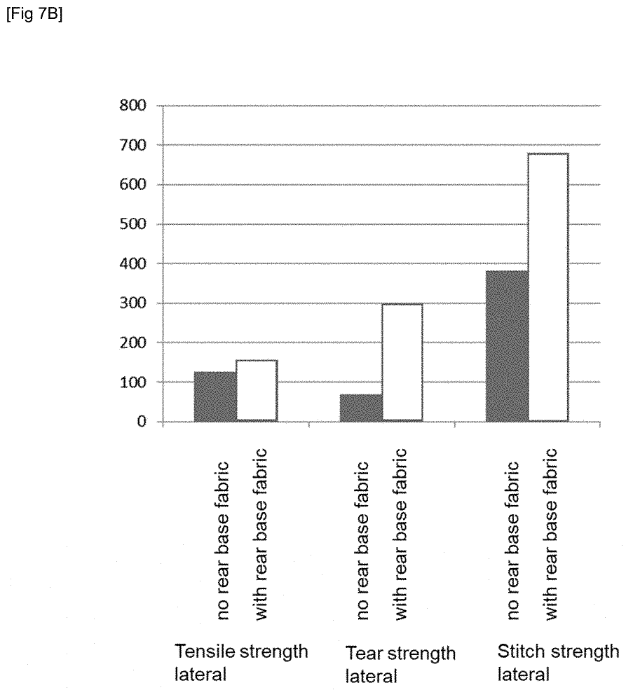

The results are shown in FIGS. 7A and 7B.

From FIGS. 7A and 7B, it was confirmed that the strength (especially tear strength and seam strength) could be improved and the required strength could be satisfied by integrating with the rear base fabric even if the strength of the interior material for the vehicle was insufficient for the surface layer alone.

### <Air Permeability>

The volume of air (cm³/cm²/s) passing through the resulting Example product (A) and the Comparative products (B) and (C) was measured using a Frasier-type testing machine (FX3300, manufactured by TEXTEST) under a constant differential pressure (pressure difference when air passes through the test surface). The results are shown below.

The test is based on JIS L 1096 8 26.1 Method A. The mean of three samples with an angle of 180×180 mm.

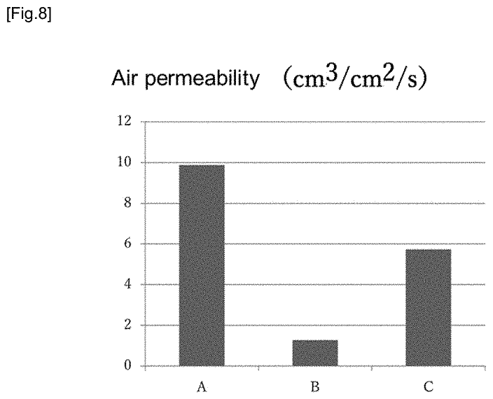

FIG. 8 shows that the Example product (A) has the highest air permeability and tends to be less stuffy in cases where people are in contact with it for a long time, such as in vehicle seats.

Further, as a reason for the high air permeability of the Example product (A), the point that the urethane resin is not impregnated into the dough itself and the adhesive method in which the front and back layers are bonded are derived from point adhesion.

1. A suede-like surface material for vehicle interior having at least a surface layer, an adhesive layer and a rear surface layer, wherein the surface layer comprises a textile containing a split yarn.

2. The suede-like surface material according to claim 1, wherein the textile includes a warp yarn comprising a combined twisted yarn containing a split yarn and a high stretching yarn or a high shrinkage yarn, and a weft yarn comprising a polyester crimped yarn.

3. The suede-like surface material according to claim 1, wherein the adhesive layer comprises a solvent-free polyester-based polyurethane adhesive.

4. The suede-like surface material according to claim 1, wherein the rear surface layer comprises a knitted material and a tissue of the knitted material is a tricot or a jersey.
